(19) United States
(12) Patent Application Publication
(10) Pub. No.: US 2026/0023988 A1
(43) Pub. Date: Jan. 22, 2026

(54) KNOWLEDGE GRAPH COMPLETION USING PRETRAINED LARGE LANGUAGE MODELS

(71) Applicant: HEWLETT PACKARD ENTERPRISE DEVELOPMENT LP, Spring, TX (US)

(72) Inventors: Revathy Venkataramanan, Columbia, SC (US); Aalap Tripathy, Houston, TX (US); Sergey Serebryakov, Milpitas, CA (US); Suparna Bhattacharya, Bangalore (IN); Annmary Justine Koomthanam, Fort Collins, CO (US); Tarun Kumar, Bangalore (IN); Martin Foltin, Fort Collins, CO (US); Arpit Shah, Bangalore (IN)

(21) Appl. No.: 18/911,921

(22) Filed: Oct. 10, 2024

(30) Foreign Application Priority Data
Jul. 16, 2024 (IN) 202441054244

(51) Int. Cl. G06N 5/022

(52) U.S. Cl. CPC G06N 5/022

(57) ABSTRACT

Systems and methods are provided for completing a knowledge graph associated with an artificial intelligence pipeline. For example, the system may determine a missing data element in a knowledge graph, initiate an extraction process from a manuscript file associated with identifying the missing data element in the knowledge graph, initiate an intent identification process of the manuscript file that generates a label for a cluster of terms of the manuscript file, provide the cluster of terms from the manuscript file and the label as input to a large language model (LLM), and iteratively update the knowledge graph with output from the LLM.

### BACKGROUND

A knowledge graph is a data structure that comprises nodes, edges, and properties to represent relationships between various data. In general, the edges represent the relationships between the nodes. The nodes of the knowledge graph represent entities or instances such as an item to be tracked in a record of a relational data store. Each node may correspond with various properties of the node. The edges are the lines that connect nodes to other nodes and represent the relationship between them. Meaningful patterns emerge when examining the connections and interconnections of nodes and edges and the relationships between the nodes and edges can allow data in the data store to be linked together directly.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a pipeline graphing device, manuscript device, and a set of manuscript data stores for completing a knowledge graph, in accordance with some examples described herein.

FIG. 2 is an illustrative process for completing a knowledge graph using a pipeline graphing device, in accordance with some examples described herein.

FIG. 3 illustrates a knowledge graph with a set of missing data elements, in accordance with some examples described herein.

FIG. 4 is an illustrative process for accessing a missing data element for a knowledge graph using a pipeline graphing device, in accordance with some examples described herein.

FIG. 5 illustrates a process for identifying intent in a manuscript associated with a knowledge graph, in accordance with some examples described herein.

FIG. 6 illustrates a knowledge graph with the missing data elements identified, in accordance with some examples described herein.

FIG. 7 is an example process for completing a knowledge graph, in accordance with some examples described herein.

FIG. 8 is an example computing component that may be used to implement various features of embodiments described in the present disclosure.

The figures are not exhaustive and do not limit the present disclosure to the precise form disclosed.

### DETAILED DESCRIPTION

Knowledge graphs and corresponding data structures can be used to programmatically define features of various computational resources, including artificial intelligence (AI) models and systems that are used to train the AI models. This is especially helpful in mapping devices that are utilized during the training process of the AI model to produce meaningful and accurate inferences of physical data structures and devices in an environment and metrics on how they interact.

For example, traditional development of AI models often corresponds with a complex and resource-intensive process. Some AI models are trained on massive datasets, often with a ground-truth or correct data, in order to create a model-centric view of model training. Other AI models implement a pipeline-centric view, where the training process analyzes the entire process of creating the AI model (e.g., from data ingestion to data cleaning, model training, testing and validation) instead of focusing just on the AI model. The pipeline-centric sequence of stages is also known as the “AI pipeline.” Stages in AI pipelines are defined by a large number of parameters and a large amount of computational resources.

Some systems can build a knowledge graph associated with the AI pipeline or AI pipeline metadata knowledge graph (interchangeably referred to as the “knowledge graph” or “AI pipeline metadata knowledge graph”). The AI pipeline metadata knowledge graph can identify AI pipelines that exist in the environment. However, the data used by traditional systems to create the AI pipeline metadata knowledge graph is not always complete. For example, the knowledge graph may be complete when the knowledge graph comprises no missing nodes, edges, and metadata associated with them, or when the knowledge graph comprises a threshold number of nodes and edges, and metadata is associated with each of the nodes. As such, the illustrative systems and methods described herein may identify missing data used to create the AI pipeline metadata knowledge graph and supplement or generate it. For example, the system may determine a missing data element in the AI pipeline metadata knowledge graph, initiate an extraction process from a manuscript file associated with identifying the missing data element in the knowledge graph, initiate an intent identification process of the manuscript file that generates an intent label for a cluster of terms of the manuscript file, provide the cluster of terms from the manuscript file and the intent label as input to a large language model (LLM), and iteratively update the knowledge graph with output from the LLM.

More detailed information may be extracted from the manuscript files. The extracted data may comprise information about AI tasks (e.g., image classification, object detection, etc.), datasets (e.g., name, size, number of features, etc.), data preprocessing techniques (e.g., removing outliers, imputing missing values, train/test split, etc.) and augmentations (e.g., resize, mirror, rotate, etc.), AI model types (e.g., neural networks, gradient boosted trees, etc.) and their hyperparameters (e.g., number of layers, learning rate, etc.), and AI performance metrics (e.g., train and test accuracy, training loss, etc.). Various information may be determined from the manuscript files. The system/method may supplement or generate the data and update the graph that illustrates the corresponding AI pipeline.

Various technical benefits are realized from this system. For example, the AI pipeline metadata knowledge graph with completed data elements may be utilized for generating responses by the LLM, thereby reducing processing by additional computational resources. The system can generate the response through meaningful patterns that have emerged in filling in missing data elements in the knowledge graph and utilizing connections identified through the data processing. The source of data for the LLM is improved as well.

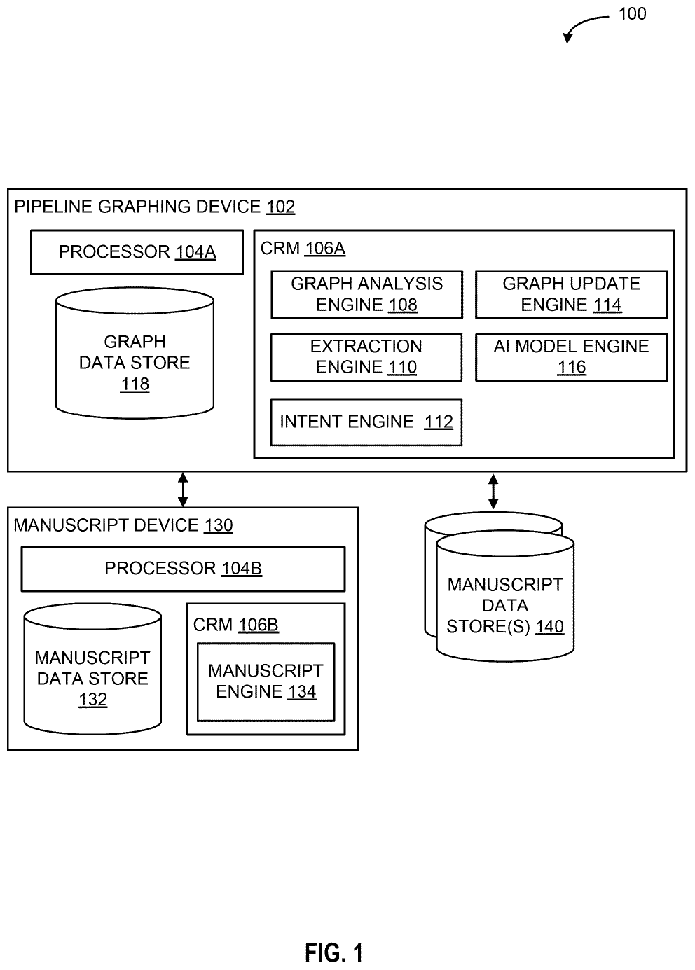

FIG. 1 illustrates a pipeline graphing device, manuscript device, and a set of manuscript data stores for completing a knowledge graph, in accordance with some examples described herein. In example 100, pipeline graphing device 102, manuscript device 130, and a set of manuscript data stores 140 for completing a knowledge graph are illustrated. Pipeline graphing device 102 and manuscript device 130 may comprise processor 104 (illustrated as first processor 104A and second processor 104B) and computer readable medium 106 (illustrated as first computer readable medium 106A and second computer readable medium 106B).

Processor 104 may be implemented using a general-purpose or special-purpose processing engine such as, for example, a microprocessor, controller, or other control logic. Processor 104 may be connected to a bus, although any communication medium can be used to facilitate interaction with other components of the corresponding device that embeds processor 104 or to communicate externally.

Computer readable medium 106 may be implemented as random-access memory (RAM) or other dynamic memory, to be used for storing information and instructions to be executed by processor 104. Other memory might also be used for storing temporary variables or other intermediate information during execution of instructions to be executed by processor 104 or a read only memory (“ROM”) or other static storage device coupled to the bus for storing static information and instructions for processor 104.

Computer readable media 106 may comprise various engines and modules to be executed by processor 104. For example, at pipeline graphing device 102, computer readable media 106A may comprise graph analysis engine 108, extraction engine 110, intent engine 112, graph update engine 114, and AI model engine 116. The graph and corresponding data may be stored in graph data store 118. At manuscript device 130, computer readable media 106B may comprise manuscript engine 134. The manuscripts may be stored in manuscript data store 132 or externally at a standalone data store, as illustrated with manuscript data store(s) 140.

Graph analysis engine 108 is configured to determine data elements in a knowledge graph. For example, an AI model, dataset, or data metric/features may be identified in a particular AI pipeline. In some examples, graph analysis engine 108 is also configured to determine more detailed information of what is the AI model used and the metrics obtained. The data may be available in a manuscript file or written in a natural language description of the AI model.

In some examples, graph analysis engine 108 is configured to determine a missing data element in a knowledge graph. For example, a list of known data elements may be stored with pipeline graphing device 102. When a data element is determined in the manuscript file, the data element may be matched to the list of known data elements. Any elements from the list of known data elements that are not identified in the graph may be determined to be missing and may be determined from an analysis of the manuscript file.

In some examples, the list of known data elements may be clustered as required data elements and optional data elements. When a required data element from the list of known data elements is missing or incomplete, the data element may be identified as a missing data element. When an optional data element from the list of known data elements is missing or incomplete, the data element may be identified. The optional data element may be identified as a missing data element based on a user profile or user-selected options associated with the graph or AI pipeline.

Extraction engine 110 is configured to initiate an extraction process of a manuscript file. The extraction process may comprise parsing the manuscript file to determine the figures, tables, and text that is included in the manuscript file. The manuscript file may correspond with a published journal article, a published peer review document, or other digitally-encoded document. In some examples, the information extracted from the manuscript file may comprise the dataset used for training or inference determinations of the AI model or the associated AI pipeline.

In some examples, the extraction process may be associated with identifying the missing data element in the knowledge graph. For example, an AI pipeline with one or more missing data elements may be identified. For one or more of the AI pipelines, a corresponding manuscript file may be determined for the incomplete AI pipeline (e.g., any AI pipeline with a missing data element). As an illustrative example, pipeline graphing device 102 may store 200,000 complete AI pipelines and 800,000 incomplete AI pipelines in graph data store 118. As such, manuscript files associated with the missing data elements for the 800,000 incomplete AI pipelines may be determined.

As an illustrative example, the extraction process may identify metadata associated with the manuscript file as being the missing data element. Various data may correspond with the missing data element, as described throughout the disclosure, including AI tasks (e.g., image classification, object detection, etc.), datasets (e.g., name, size, number of features, etc.), data preprocessing techniques (e.g., removing outliers, imputing missing values, train/test split, etc.) and augmentations (e.g., resize, mirror, rotate, etc.), AI model types (e.g., neural networks, gradient boosted trees, etc.) and their hyperparameters (e.g., number of layers, learning rate, etc.), and AI performance metrics (e.g., train and test accuracy, training loss, etc.). For example, the file name of the manuscript file can be identified outside of the text of the manuscript file (e.g., as the publisher of the manuscript file). In another example, the author may belong to a research group and is completing her PhD at a university who specializes in a particular field. The field may be added as a node in the knowledge graph.

In some examples, the extraction process comprises extracting data from the manuscript files that can identify a machine learning task. The machine learning task may be selected from one of an image classification process or an object detection process.

In some examples, the extraction process comprises extracting data from the manuscript files that can identify a dataset that is defined using a name, file size, a number of features, or other attributes in the dataset.

In some examples, the extraction process comprises extracting data from the manuscript files that can identify data preprocessing techniques. In some examples, the data preprocessing techniques are selected from one of removing outliers, imputing missing values, or determining a training or testing split of the data.

In some examples, the extraction process comprises extracting data from the manuscript files that can identify augmentations of the manuscript files selected from one of resizing, mirroring, or rotating the data.

In some examples, the extraction process comprises extracting data from the manuscript files that can identify artificial intelligence (AI) model types. In some examples, the AI model types are selected from one of a neural network, a gradient boosted tree, or hyperparameters of the AI model types comprising a number of layers or a learning rate.

In some examples, the extraction process comprises extracting data from the manuscript files that can identify artificial intelligence (AI) performance metrics. In some examples, the AI performance metrics are selected from one of an accuracy value or a training loss value.

Intent engine 112 is configured to initiate an intent identification process of the manuscript file. The intent identification process may generate an intent label for a cluster of terms of the manuscript file. For example, the cluster of terms of the manuscript file may be a paragraph or a figure of the manuscript file and the intent label may be the intent of the paragraph or the figure. In these examples, the paragraph and figure of the manuscript file are provided as illustrative purposes of the system and should not be limiting to the disclosure. Various other groupings of terms may be implemented as well, including paragraphs, sentences, figures, tables, a summary, or abstract.

In some examples, intent engine 112 may determine an intent of a cluster of terms (e.g., paragraph, sentence, figure, table, summary, abstract, or other grouping of terms) in a manuscript file and the cluster of terms or paragraphs with the intent identified may be input to the large language model (LLM) for entity extraction. For example, the input to the LLM may comprise a question (e.g., “What is the dataset used in paragraph-1?”). The expected response may comprise a name of a dataset (e.g., “ImageNet”). The output by the LLM (e.g., the name of the dataset) may be provided to the knowledge graph to update the missing data element. A similar process may be implemented for the AI model, metrics, and other entities that the process can extract.

In some examples, the LLM may be trained by an external device. In some examples, the LLM is trained by a source during a training phase, and then implemented on new data, during an inference phase, to determine inferences/output of the cluster of terms.

As an illustrative example, a 10-page manuscript file can be identified and a paragraph in the manuscript file can be identified. The paragraph may reduce the amount of information that is provided to the LLM. The prompt/query may be provided to the LLM after the intent is identified for the cluster of terms to help extract the name of the entities. The output may identify the intent of the paragraph and the knowledge graph may be constructed with a node that identifies the same for the particular paragraph in the manuscript file (e.g., the evaluation results are being presented in the table). When an existing graph is available, graph update engine 114 may update the node or create a new node with the additional information (e.g., regarding the intent of the paragraph).

Graph update engine 114 is configured to iteratively update the knowledge graph to generate an updated knowledge graph. For example, the updating may use the output of the LLM to generate the missing data element.

In some examples, graph update engine 114 may determine the similarities between the semantic values of the cluster of terms and other data, including embeddings, semantic properties, and other data features. The relationships may be loaded to a process that generates the portions of the knowledge graph to add these portions to the existing graph and update the graph.

AI model engine 116 is configured to generate, using a large language model (LLM), a response using the updated knowledge graph. For example, the updated knowledge graph may be accessed in association with receiving a prompt via an LLM. The updated knowledge graph may be mapped to the prompt. Pipeline graphing device 102 may analyze the graph to determine the response within the restricted amount of information provided by the graph.

In some examples, AI model engine 116 is configured to generate and train an AI model. For example, the AI model may be trained to generate the response and a confidence score by applying a plurality of data as input, and the AI model may generate the response and confidence score. The training process may first preprocess the plurality of data, including initiating a data formatting process, where the manuscript files or other data are converted from different manuscript file types (e.g., image format, Word® format, etc.) into a unified digital format (e.g., PDF file). The preprocessing may also include data extraction to help segment the data that may be irrelevant. The data extraction may discard/extract information, for example using optical character recognition (OCR) and natural language processing (NLP) techniques.

The training process may implement feature extraction on the data. For example, once the preprocessing of the data is initiated, the input may be broken down into smaller units or tokens during a tokenization process. These tokens could be words, subwords, or characters, depending on the tokenization scheme used by the model. The feature extraction may also include an embedding lookup process, where embeddings are generated as high-dimensional vector representations of the tokens. These embeddings may correspond with semantic and syntactic properties of the tokens and mathematical relationships between the tokens.

In some examples, the feature extraction process may encode the embeddings for the individual tokens using transformers or recurrent neural networks. Using these encodings, the feature extraction process may extract relevant features from the encoded representations by transforming the encoded representations into feature vectors. In some examples, the feature extraction process may reduce the dimensionality of the extracted features using a dimensionality reduction technique (e.g., principal component analysis (PCA) or t-distributed Stochastic Neighbor Embedding (t-SNE), etc.).

In some examples, the feature extraction process may normalize or scale the feature vectors (e.g., z-score normalization or min-max scaling, etc.) to create consistent ranges and distributions for the extracted features. When normalization is incorporated with the feature extraction process, normalization can help prevent features with large magnitudes from dominating the learning process and ensure that the model can effectively learn from the input data.

In some examples, the feature extraction process may implement feature selection (e.g., technique like filtering or wrapper methods), discard irrelevant or redundant features, and generate an output. The output of the feature selection process may be used as input to downstream tasks, such as classification, regression, sequence generation, or generating output text for the model based on the learned patterns and relationships in the input data. As illustrative examples, the training may comprise a cross-entropy loss to classify the input data, and a mean squared error for regression tasks.

AI model engine 116 is also configured to generate a confidence score with the output/inference. Various processes may be implemented to generate the confidence score associated with the response, including a Naive Bayes classifier, logistic regression, and neural network-based structured prediction. In some examples, a set of responses are generated and the response with the highest confidence score may be provided to the user interface where the LLM is deployed.

The AI model may take various forms. For example, the AI model may correspond with deep learning, logistics, random forest, linear regression, naïve Bayes, support vector machines (SVM), supervised/unsupervised learning, and others. The type of model may be determined based on the task where the AI model is used.

In some examples, manuscript device 130 and a set of manuscript data stores 140 may be sources of manuscript files. In some examples, pipeline graphing device 102 may access either of these data sources to identify the relevant manuscript files and execute the processes described herein.

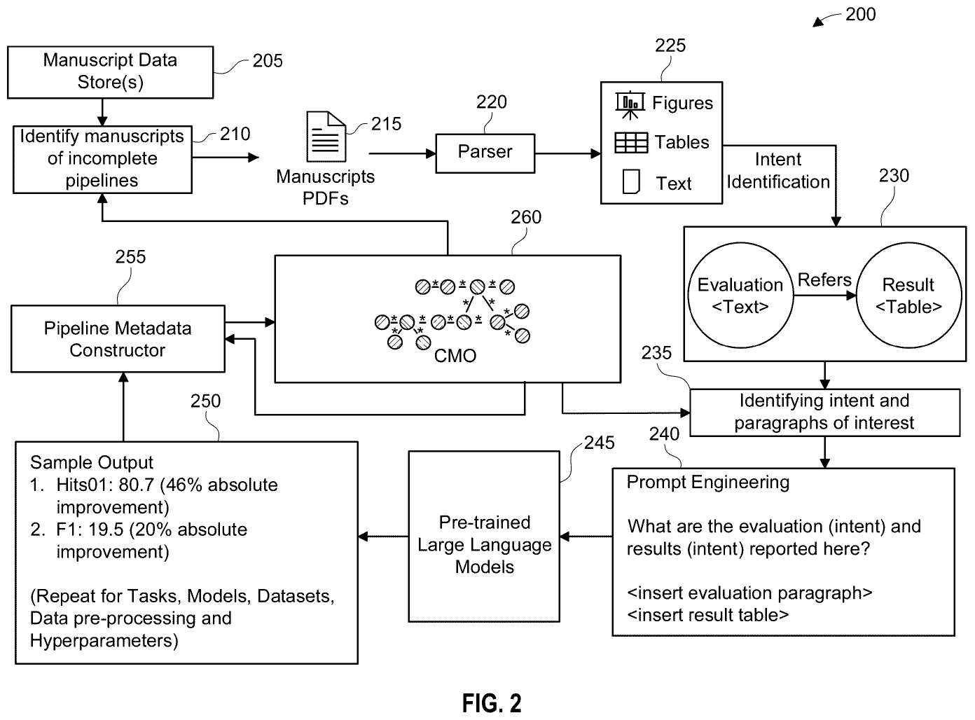

FIG. 2 is an illustrative process for completing a knowledge graph using a pipeline graphing device, in accordance with some examples described herein. In example 200, a process associated with a knowledge graph is illustrated using various devices, including a pipeline graphing device. The device executing machine-readable instructions in example 200 may correspond with pipeline graphing device 102 in FIG. 1.

At block 205, a manuscript data store is generated and maintained. The manuscript data store may be implemented with a manuscript device, which may correspond with manuscript device 130 in FIG. 1 or a standalone manuscript data store, as illustrated as manuscript data store 140 in FIG. 1.

At block 210, the process may identify the manuscript data store associated with any incomplete AI pipelines in the system. For example, a list of known data elements may be stored with the AI model. When a data element is determined in the manuscript file, the data element may be matched to the list of known data elements. Any elements from the list of known data elements that are not identified in the manuscript file may be determined to be missing.

Various data elements may be extracted from the manuscript file. The extracted data may comprise information about AI tasks (e.g., image classification, object detection, etc.), datasets (e.g., name, size, number of features, etc.), data preprocessing techniques (e.g., removing outliers, imputing missing values, train/test split, etc.) and augmentations (e.g., resize, mirror, rotate, etc.), AI model types (e.g., neural networks, gradient boosted trees, etc.) and their hyperparameters (e.g., number of layers, learning rate, etc.), and AI performance metrics (e.g., train and test accuracy, training loss, etc.).

In some examples, each AI pipeline may correspond with its own ontology when the AI model is acquired. The data elements associated with the ontology may comprise, for example, an identifier, parameter setting, source, model identifier, custom properties, class, AI pipeline identifier, or other data elements. The manuscript file may be the source of the AI model and provide definitions of various data elements. In these examples, the list of known data elements may be completed based on the information included with the manuscript file and missing information from the manuscript file may be associated with a missing data element.

In some examples, the source of the AI model may be experiment centric, for example, by originating from a third party source, originating from an open AI source, or originating from an internal data store. In these examples, the list of known data elements may be completed based on the information included with the description of the experiment.

At block 215, the manuscript files may be accessed or retrieved from the manuscript data store and converted to a machine-readable file. An illustrative example of the machine-readable file is shown as a PDF although other file types are available without diverting from the essence of the disclosure.

At block 220, the manuscript file may be provided to a parser or other device that implements an extraction process on the manuscript file. During the extraction process, portions of the manuscript file may be identified, including figures, tables, or text of the manuscript file, as shown in block 225. In some examples, the extraction process may parse the manuscript file by generating a cluster of terms of the manuscript file corresponding with a paragraph or other grouping of texts and values in the manuscript file.

As an illustrative example, the extraction process may identify a figure or table in the manuscript file and analyze the captions of the figure or table. In some examples, the figures or tables may be removed and only the captions may be analyzed/stored. The extraction process may convert the captions into the text document or in the form of a text natural language text or other readable format for input to an LLM (e.g., in accordance with a token format of the LLM). The extraction process may generate the cluster of terms of the manuscript file.

At block 230, a portion of a manuscript file is illustrated as nodes and an edge of a knowledge graph. The nodes are identified as an evaluation (text) referring to a result (table). These terms may correspond with labels that are added during an intent identification process before the entity extraction using LLM (referred to interchangeably as “intent labels”).

At block 235, the process may initiate an intent identification process of the manuscript file. The intent identification process may associate the cluster of terms in the manuscript file with a result, finding, table, or other output associated with the cluster of terms. In some examples, the output may be associated with a label that can help classify the cluster of terms. For example, upon completion of the intent identification process, the cluster of terms (e.g., paragraph) containing AI pipelines entities such as dataset, model, and other features can be identified to be given as input to LLM. The LLM will then do the entity extraction such as the names of dataset, model, hyperparameters, and etc.

At block 240, the process may initiate prompt engineering to analyze the natural language text of the manuscript file by creating queries to extract this information. The prompt engineering may generate the queries that are provided as input to an LLM (block 245) and generate output (block 250) as a response generated by the LLM to the queries.

In some examples, the input to the LLM is the cluster of terms with the intent that has been previously identified. The intent may be used to help extract the names of dataset, task, and other entities from the paragraph. In some examples, the extraction process determines the task data, model hyperparameters, and other features of the AI model described in the manuscript file.

In some examples, the cluster of terms may be used to limit the amount of information that is provided as input to the LLM (block 245). By reducing the amount of data that is provided as input to the LLM, the process can help reduce the hallucination of data in generating the output (block 250) and restrict the amount of data that is generated randomly or not present in the particular paragraph that was provided as input.

At block 255, the process may implement a pipeline metadata constructor that can iteratively or sequentially update the knowledge graph to generate an updated knowledge graph. For example, the process may access the AI pipeline from various manuscript file data sources. The graph may be stored in the graph data store (e.g., graph data store 118 in FIG. 1) and updated through this process (e.g., identify manuscript files of missing data elements or incomplete AI pipeline), parsing, determining the intent of clusters of terms, and then use that graph to implement prompt engineering (e.g., via graph update engine 114 of FIG. 1).

At block 260, the process may store the updated knowledge graph. The graph may be stored in a graph data store (e.g., graph data store 118 in FIG. 1).

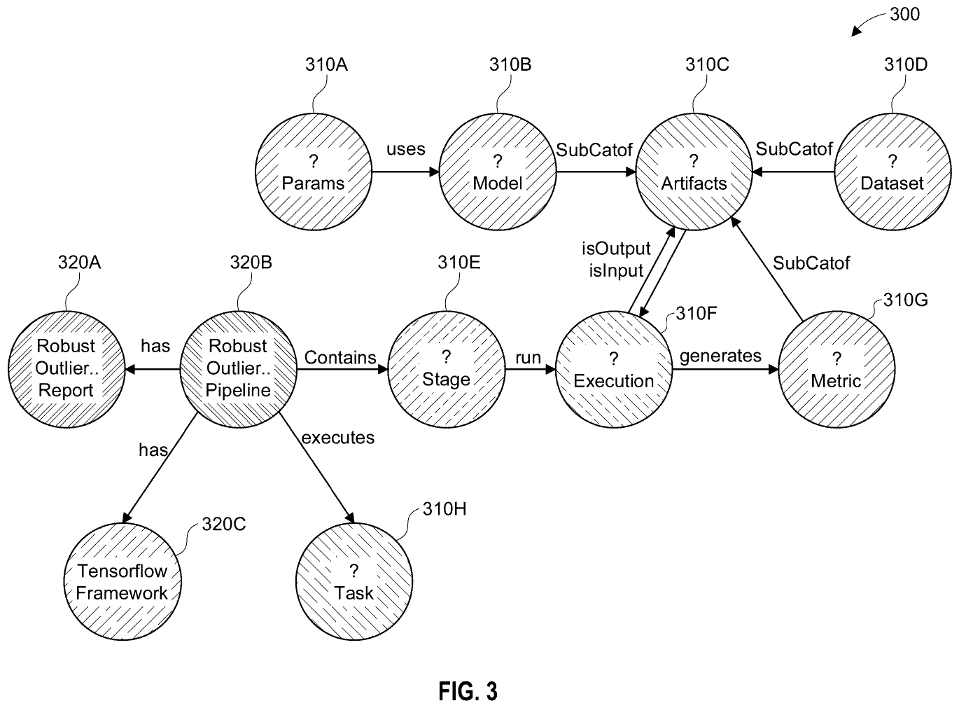

FIG. 3 illustrates a knowledge graph with a set of missing data elements, in accordance with some examples described herein. In example 300, a knowledge graph is provided. In the knowledge graph, various types of data elements are provided, including missing/unknown data elements 310 and known data elements 320. Missing data elements 310 may comprise parameters 310A, AI model 310B, artifacts 310C, dataset 310D, stage 310E, execution 310F, metric 310G, and task 310H. Known data elements 320 may comprise a report 320A (e.g., a robust outlier report), an AI pipeline 320B (e.g., a robust outlier pipeline), and framework 320C (e.g., TensorFlow).

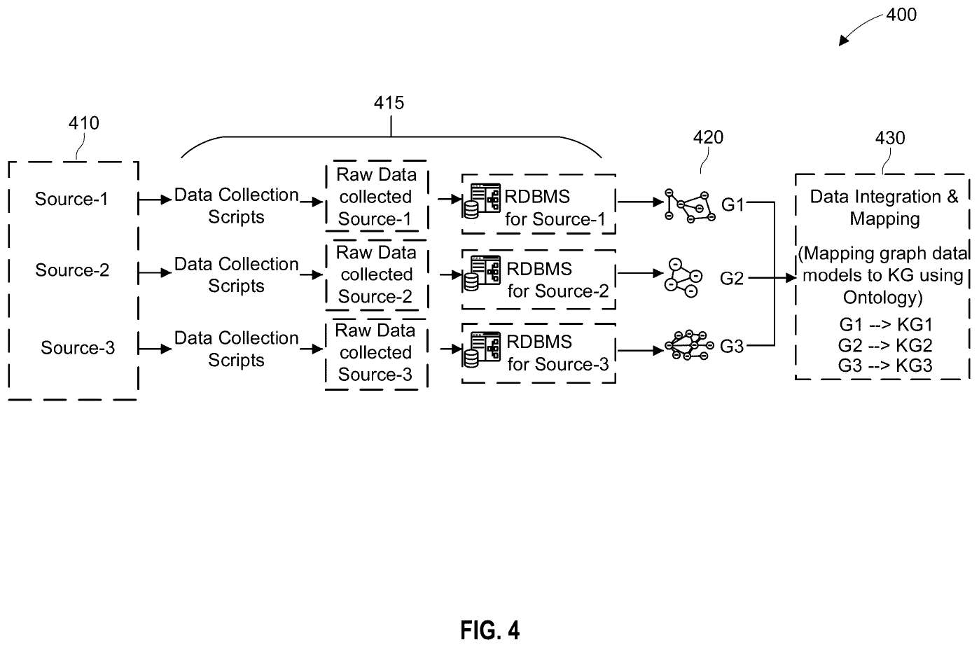

FIG. 4 is an illustrative process for accessing a missing data element for a knowledge graph using a pipeline graphing device, in accordance with some examples described herein. In example 400, various sources of manuscript files are identified and available for analysis through the extraction process described herein. For example, at block 410, the manuscript file may correspond with public or private data stores from various sources. After data extraction and parsing executed through a set of processes and methods 415, graphs 420 may be generated for each AI pipeline in the various data sources. The missing data elements may be identified in each of the graphs using data integration and mapping 430 of the generated graphs.

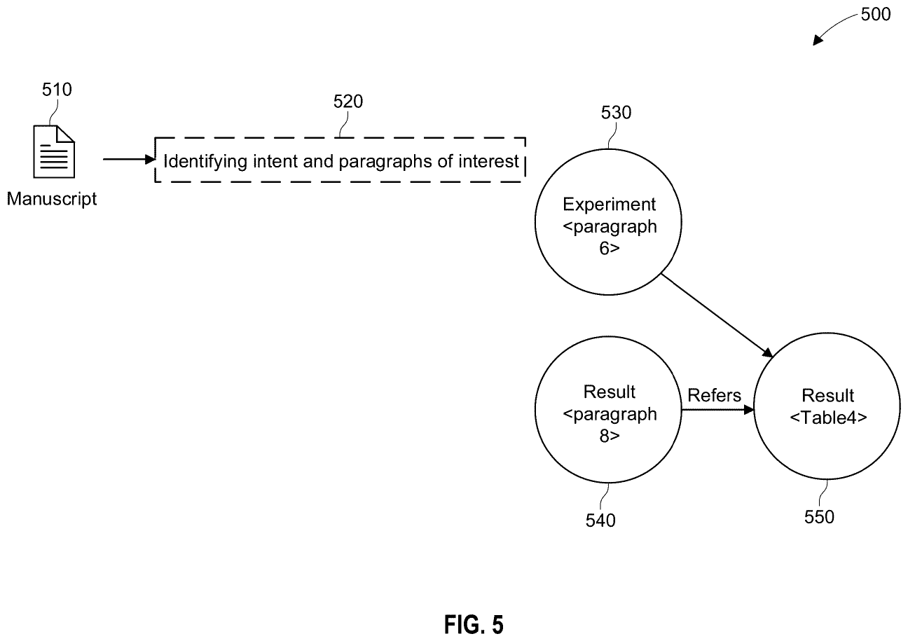

FIG. 5 illustrates a process for identifying intent in a manuscript associated with a knowledge graph, in accordance with some examples described herein. In example 500, the LLM is utilized to execute prompts/queries on the processed manuscript files. For example, the process may select the AI pipeline metadata knowledge graph and access the manuscript files associated with the AI pipeline metadata knowledge graph. This process may help identify which cluster of terms can be relied on to provide as input to the LLM and accurately answer the query/prompt that is generated.

At block 510, a manuscript file is provided. The manuscript file may comprise paragraphs of text, figures, tables, equations and all other information.

At block 520, the process may initiate the intent identification process of the manuscript file. The intent identification process may review the clusters of terms in the manuscript file and determine the intent of the paragraph.

At block 530, paragraph 6 of the manuscript file is analyzed and labeled as being related to an “experiment.” For example, the experiment may reference experimentation techniques and the metrics that are going to be used.

At block 540, paragraph 8 of the manuscript file is analyzed and labeled as referring to a “result.”

At block 550, table 4 of the manuscript file is analyzed and labeled as referring to a “result.” Edges/links between these portions of the manuscript may also be identified during the intent identification process, such that the result in table 4 is related to both the experiment at paragraph 6 and the description of the results at paragraph 8.

In other examples, an AI model may be described in text of the manuscript file and also illustrated in a figure of the manuscript file. These paragraphs and figure may be associated with each other in the knowledge graph using nodes and edges, as illustrated herein.

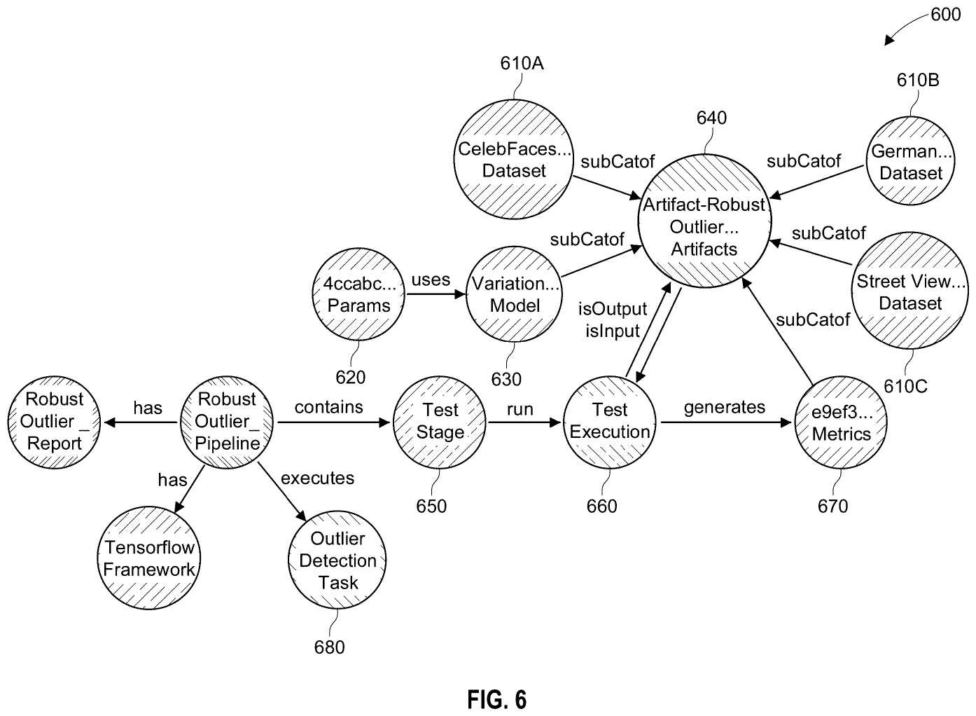

FIG. 6 illustrates a knowledge graph with the missing data elements identified, in accordance with some examples described herein. In example 600, an updated knowledge graph is shown in comparison to the knowledge graph of FIG. 3.

Various missing/unknown data elements are provided and known data elements may be repeated and provided with the previously-missing data elements. For example, a set of datasets 610 are provided, including first dataset 610A (CelebFaces . . . ), second dataset 610B (German . . . ), and third dataset 610C (Street View . . . ). Other data elements may be determined as well, including parameters 620 (4ccabc . . . ), AI model 630 (variation), artifacts 640 (Artifact-Robust Outlier . . . ), stage 650 (test), execution 660 (test), metrics 670 (e9ef3 . . . ), and AI task (outlier detection). Other values and data elements are available for implementation, without diverting from the essence of the disclosure.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

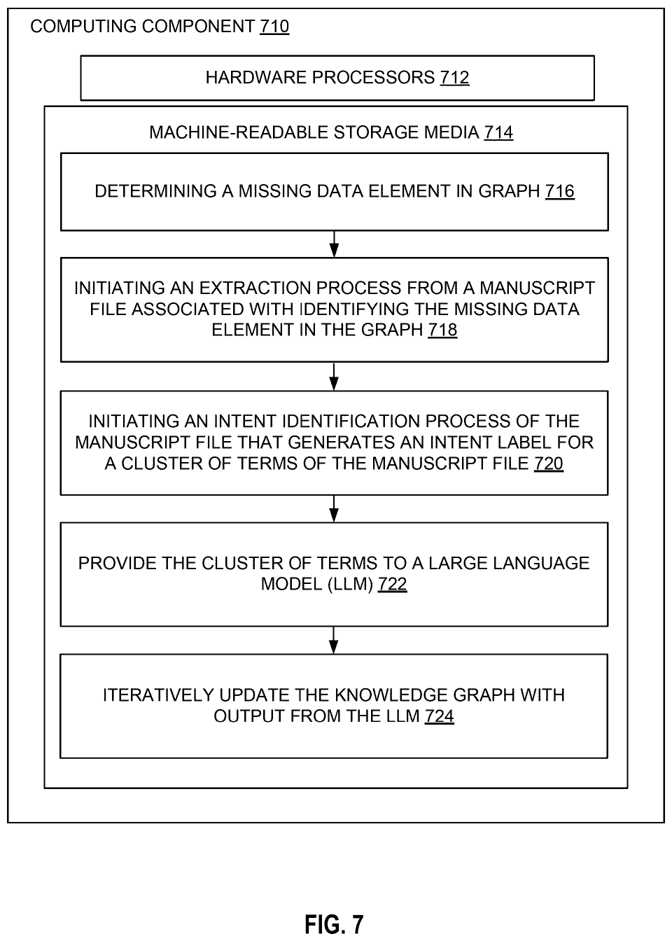

FIG. 7 illustrates an example computing component that may be used to iteratively update a knowledge graph in accordance with various embodiments. Computing component 710 may be, for example, a server computer, a controller, or any other similar computing component capable of processing data. In the example, computing component 710 includes hardware processor 712 and machine-readable storage medium 714.

Hardware processor 712 may be one or more central processing units (CPUs), semiconductor-based microprocessors, and/or other hardware devices suitable for retrieval and execution of instructions stored in machine-readable storage medium 714. Hardware processor 712 may fetch, decode, and execute instructions, such as instructions 716-724, to control processes or operations for iteratively updating a knowledge graph. As an alternative or in addition to retrieving and executing instructions, hardware processor 712 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 714, may be any electronic, magnetic, optical, or other physical storage device that contains or stores executable instructions. Thus, machine-readable storage medium 714 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 714 may be a non-transitory storage medium, where the term “non-transitory” does not encompass transitory propagating signals. As described in detail below, machine-readable storage medium 714 may be encoded with executable instructions, for example, instructions 716-724.

At block 716, hardware processor 712 is configured to determine a missing data element in a knowledge graph. For example, a list of known data elements may be stored. When a data element is determined in the manuscript file, the data element may be matched to the list of known data elements. Any elements from the list of known data elements that are not identified in the graph may be determined to be missing and may be determined from an analysis of the manuscript file.

In some examples, the list of known data elements may be clustered as required data elements and optional data elements. When a required data element from the list of known data elements is missing or incomplete, the data element may be identified as a missing data element. When an optional data element from the list of known data elements is missing or incomplete, the data element may be identified. The optional data element may be identified as a missing data element based on a user profile or user-selected options associated with the graph or AI pipeline.

At block 718, hardware processor 712 is configured to initiate an extraction process from a manuscript file associated with identifying the missing data element in the knowledge graph. For example, the extraction process may comprise parsing the manuscript file to determine the figures, tables, and text that is included in the manuscript file. The manuscript file may correspond with a published journal article, a published peer review document, or other digitally-encoded document. In some examples, the information extracted from the manuscript file may comprise the dataset used for training or inference determinations of the AI model or the associated AI pipeline.

Various data may correspond with the missing data element, as described throughout the disclosure, including AI tasks (e.g., image classification, object detection, etc.), datasets (e.g., name, size, number of features, etc.), data preprocessing techniques (e.g., removing outliers, imputing missing values, train/test split, etc.) and augmentations (e.g., resize, mirror, rotate, etc.), AI model types (e.g., neural networks, gradient boosted trees, etc.) and their hyperparameters (e.g., number of layers, learning rate, etc.), and AI performance metrics (e.g., train and test accuracy, training loss, etc.)

At block 720, hardware processor 712 is configured to initiate an intent identification process of the manuscript file that generates a label for a cluster of terms of the manuscript file.

At block 722, hardware processor 712 is configured to provide the cluster of terms from the manuscript file and the label as input to a large language model (LLM).

At block 724, hardware processor 712 is configured to iteratively update the knowledge graph with output from the LLM.

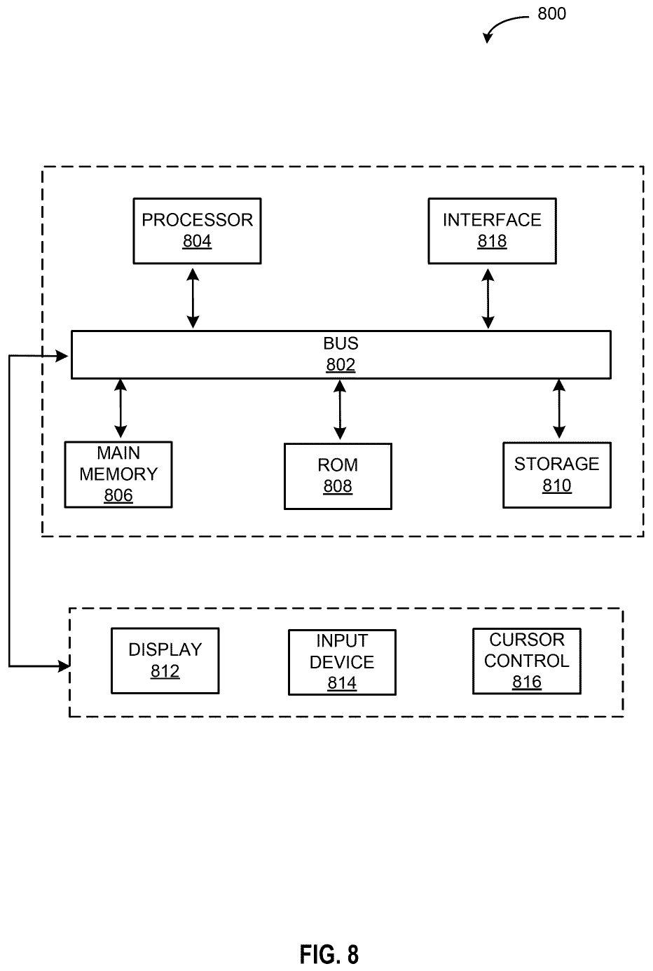

FIG. 8 depicts a block diagram of an example computer system 800 in which various examples described herein may be implemented. Computer system 800 includes bus 802 or other communication mechanism for communicating information, one or more hardware processors 804 coupled with bus 802 for processing information. Hardware processor(s) 804 may be, for example, one or more general purpose microprocessors.

Computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes read only memory (ROM) 808 or other static storage device coupled to bus 802 for storing static information and instructions for processor 804. Storage device 810, such as a magnetic disk, optical disk, or USB thumb drive (Flash drive), etc., is provided and coupled to bus 802 for storing information and instructions.

Computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some embodiments, the same direction information and command selections as cursor control may be implemented via receiving touches on a touch screen without a cursor.

Computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

Computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicate with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

The computer system 800 can send messages and receive data, including program code, through the network(s), network link and interface 818. In the Internet example, a server might transmit a requested code for an application program through the Internet, the ISP, the local network, and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
determining a missing data element in a knowledge graph;
initiating an extraction process from a manuscript file associated with identifying the missing data element in the knowledge graph;
initiating an intent identification process of the manuscript file that generates an intent label for a cluster of terms of the manuscript file;
providing the cluster of terms from the manuscript file and the intent label as input to a large language model (LLM); and
iteratively updating the knowledge graph with output from the LLM.

2. The computer-implemented method of claim 1, wherein the extraction process from the manuscript files identifies a name and description of a machine learning or deep learning task.

3. The computer-implemented method of claim 1, wherein the extraction process from the manuscript files identify a dataset that is defined using a name or file size in the dataset.

4. The computer-implemented method of claim 1, wherein the extraction process from the manuscript files identify data preprocessing techniques, and wherein the data preprocessing techniques are selected from one of removing outliers, imputing missing values, or determining a training or testing split of the data.

5. The computer-implemented method of claim 1, further comprising:
initiating a data preprocessing process that identifies at least one of augmentations, resizing, mirroring, and removing outliers.

6. The computer-implemented method of claim 1, wherein the extraction process from the manuscript files identify artificial intelligence (AI) model types, and wherein the AI model types are selected from one of a neural network, a gradient boosted tree, or hyperparameters of the AI model types comprising a number of layers or a learning rate.

7. The computer-implemented method of claim 1, wherein the extraction process from the manuscript files identify artificial intelligence (AI) performance metrics, and wherein the AI performance metrics are selected from one of an accuracy value or a training loss value.

8. The computer-implemented method of claim 1, wherein the cluster of terms of the manuscript file is a paragraph or a figure of the manuscript file, and the intent label is the intent of the paragraph or the figure.

9. A computer system comprising:
a memory; and
a processor that are configured to execute machine readable instructions stored in the memory for causing the processor to:
determine a missing data element in a knowledge graph;
initiate an extraction process from a manuscript file associated with identifying the missing data element in the knowledge graph;
initiate an intent identification process of the manuscript file that generates an intent label for a cluster of terms of the manuscript file;
provide the cluster of terms from the manuscript file and the intent label as input to a large language model (LLM); and
iteratively update the knowledge graph with output from the LLM.

10. The computer system of claim 9, wherein the extraction process from the manuscript files identify a name and description of a machine learning or deep learning task.

11. The computer system of claim 9, wherein the extraction process from the manuscript files identifies a dataset that is defined using a name or file size in the dataset.

12. The computer system of claim 9, wherein the extraction process from the manuscript files identify data preprocessing techniques, and wherein the data preprocessing techniques are selected from one of removing outliers, imputing missing values, or determining a training or testing split of the data.

13. The computer system of claim 9, wherein the processor is further caused to: initiate a data preprocessing process that identifies at least one of augmentations, resizing, mirroring, and removing outliers.

14. The computer system of claim 9, wherein the extraction process from the manuscript files identify artificial intelligence (AI) model types, and wherein the AI model types are selected from one of a neural network, a gradient boosted tree, or hyperparameters of the AI model types comprising a number of layers or a learning rate.

15. The computer system of claim 9, wherein the extraction process from the manuscript files identify artificial intelligence (AI) performance metrics, and wherein the AI performance metrics are selected from one of an accuracy value or a training loss value.

16. The computer system of claim 9, wherein the cluster of terms of the manuscript file is a paragraph or a figure of the manuscript file, and the intent label is the intent of the paragraph or the figure.

17. A non-transitory computer-readable storage medium storing a plurality of instructions executable by a processor, the plurality of instructions when executed by the processor cause the processor to:
determine a missing data element in a knowledge graph;
initiate an extraction process from a manuscript file associated with identifying the missing data element in the knowledge graph;
initiate an intent identification process of the manuscript file that generates an intent label for a cluster of terms of the manuscript file;
provide the cluster of terms from the manuscript file and the intent label as input to a large language model (LLM); and
iteratively update the knowledge graph with output from the LLM.

18. The non-transitory computer-readable storage medium of claim 16, wherein the extraction process from the manuscript files identifies a name and description of a machine learning or deep learning task.

19. The non-transitory computer-readable storage medium of claim 16, wherein the extraction process from the manuscript files identify a dataset that is defined using a name or, file size in the dataset.

20. The non-transitory computer-readable storage medium of claim 16, wherein the extraction process from the manuscript files identify data preprocessing techniques, and wherein the data preprocessing techniques are selected from one of removing outliers, imputing missing values, or determining a training or testing split of the data.
